(19) United States
(12) Patent Application Publication
(10) Pub. No.: US 2025/0129275 A1
(43) Pub. Date: Apr. 24, 2025

(54) PRESSURE-SENSITIVE ADHESIVE WITH IMPROVED CHEMICAL STABILITY

(71) Applicant: TESA SE, Norderstedt (DE)

(72) Inventor: Ralf KRETZMER, Hamburg (DE)

(21) Appl. No.: 18/832,376

(22) PCT Filed: Feb. 10, 2023
(86) PCT No.: PCT/EP2023/053289

§ 371 Date: Jul. 23, 2024

(30) Foreign Application Priority Data
Feb. 11, 2022 (DE) 10 2022 103 280.9

(51) Int. Cl. C09J 7/38; C09J 11/08

(52) U.S. Cl. CPC C09J 133/10

(57) ABSTRACT

The invention relates to a pressure-sensitive adhesive comprising: a) one or more poly(meth)acrylates with a weight-average molecular weight M_{w} of 200,000 g/mol or more in a combined mass fraction of 50% or more, in relation to the mass of the pressure-sensitive adhesive, and b) one or more bonding resins with a weight-average molecular weight M_{w} of 20,000 g/mol or less in a combined mass fraction in the range of 1 to 25%, in relation to the mass of the pressure-sensitive adhesive, the one or more bonding resins being producible by polymerisation of a first monomer composition comprising, in relation to the mass of the first monomer composition: i) one or more first monomers, which are selected from the group consisting of aromatic (meth)acrylates and styrene, in a combined mass fraction in the range of 5 to 40%, ii) one or more second monomers, which are selected from the group consisting of methyl methacrylate and ethyl methacrylate, in a combined mass fraction in the range of 35 to 68%, and iii) one or more third monomers, which are selected from the group consisting of (meth)acrylates with a cycloaliphatic group, in a combined mass fraction in the range of 5 to 40%.

The invention relates to a pressure-sensitive adhesive and to a corresponding pressure-sensitive adhesive tape and also to the use of specific tackifier resins for increasing the peel adhesion and chemical resistance in poly(meth)acrylate-based adhesives. The use of a corresponding pressure-sensitive adhesive tape for producing a weather-resistant bond is also disclosed.

The joining of separate elements is one of the central processes in manufacturing. In addition to other methods, such as welding and soldering, for example, adhesive bonding, i.e. joining using an adhesive, is of particular importance nowadays. An alternative here to the use of formless adhesives, which are applied, for example, from a tube, are so-called adhesive tapes, the adhesive effect of which is based on the adhesives used.

For many technical applications, pressure-sensitive adhesive tapes are particularly relevant, in which a pressure-sensitive adhesive ensures the adhesive effect, being durably tacky and adhesive under normal ambient conditions. Corresponding pressure-sensitive adhesive tapes can be applied to a substrate by means of pressure and remain adhering there, but can later be removed in a more or less residue-free manner.

In the area of pressure-sensitive adhesives, poly(meth)acrylates in particular have proved to be very useful base materials. These polymeric compounds regularly have physico-chemical properties that make them ideal for use in pressure-sensitive adhesives, such as high resistance to light, weathering effects and a variety of chemicals, as well as high intrinsic peel adhesion and advantageous resistance to ageing. In addition, poly(meth)acrylate-based adhesives can be used regularly on a wide range of substrates, especially on polar and less polar substrates, for example on glass and steel, but also on plastics, such as polystyrene or polycarbonates. In the technical field of adhesive technology, there is therefore a continued interest in improving the physico-chemical properties of poly(meth)acrylate-based pressure-sensitive adhesives, in particular their technical adhesive properties.

One known approach to increasing the adhesive effect and to improving the wetting of substrates is additionally to add tackifier resins (so-called “tackifiers”), such as terpene-phenol resins or rosin resins, to poly(meth)acrylate-based pressure-sensitive adhesives. Even though the established use of tackifier resins in poly(meth)acrylate-based pressure-sensitive adhesives for obtaining particularly powerful pressure-sensitive adhesives is advantageous in many respects, it is also associated with disadvantages with regard to certain aspects, especially with regard to chemical resistance. Starting from the generally good intrinsic chemical resistance of typical poly(meth)acrylate-based pressure-sensitive adhesives, indeed, the chemical resistance is regularly impaired by the use of conventional tackifier resins. However, high chemical resistance is highly desirable for most applications where corresponding pressure-sensitive adhesives and pressure-sensitive adhesive tapes produced from them are exposed to relatively demanding environmental and weathering conditions. Chemical resistance, indeed, is crucial to the ability of the pressure-sensitive adhesives and pressure-sensitive adhesive tapes used to perform the intended tasks when joining elements over long periods of time, even if they come into contact during usage with chemicals such as water, acids or oil, for example, in a vehicle, for example.

The relevance of chemical resistance for the usage of pressure-sensitive adhesive tapes goes as far as to the extent that many requirement profiles for corresponding pressure-sensitive adhesive tapes, for example from the automotive or electronics industry, set specific minimum stipulations with regard to chemical resistance, which corresponding pressure-sensitive adhesives must achieve in order to be approved for usage. However, compliance with these stipulations by poly(meth)acrylate-based pressure-sensitive adhesives is in many cases made more difficult by the necessary use of typical tackifier resins.

Thus, in the state of the art, there is regularly a conflict of objectives between highly pronounced pressure-sensitive adhesive properties, in particular a high peel adhesion, on the one hand and an advantageous chemical resistance, i.e. a small deterioration in the peel adhesion under the influence of chemical substances, on the other hand.

The primary object of the present invention was to eliminate or at least reduce the disadvantages described above for the prior art.

In particular, the object of the present invention was to specify a pressure-sensitive adhesive which has an excellent pressure-sensitive adhesiveness and at the same time a sufficient chemical resistance, in particular to ethanol/water mixtures and oleic acid.

Thus, the object of the present invention was to specify a pressure-sensitive adhesive which resolves the conflict of objectives between the highest possible peel adhesion strength, in particular on steel and plastics, on the one hand, and excellent chemical resistance on the other hand, in the best-possible way.

In this context, it was a supplementary object of the present invention that the pressure-sensitive adhesives to be specified should ideally be producible as far as possible using starting materials and processes which are already used in the field of adhesive technology, in order to permit time-and cost-efficient production.

It was a supplementary object of the present invention to specify an advantageous pressure-sensitive adhesive tape.

In addition, it was a secondary object of the present invention to specify the use of specific tackifier resins for boosting the peel adhesion and chemical resistance in poly(meth)acrylate-based pressure-sensitive adhesives.

The inventors have now found that the above-described objects can surprisingly be achieved if specific (meth)acrylate-based tackifier resins are used in poly(meth)acrylate-based pressure-sensitive adhesives, as defined in the claims.

Surprisingly, through the use of a specific (meth)acrylate-based tackifier resin, produced from a defined monomer composition comprising a considerable fraction of aromatic (meth)acrylates and/or styrene, in poly(meth)acrylate-based pressure-sensitive adhesives, it was possible to achieve excellent stability of the peel adhesion towards the influence of various chemical substances.

The inventors here succeeded in identifying particularly suitable compositions for the (meth)acrylate-based tackifier resins, the poly(meth)acrylates used and the corresponding pressure-sensitive adhesives, where the corresponding pressure-sensitive adhesives and the individual components can advantageously be produced using starting materials and processes which are customary in the field of adhesive technology, so enabling time-and cost-efficient production without the need for particular apparatuses or specific chemicals.

The objects stated above are achieved accordingly by the subject matter of the invention as defined in the claims. Preferred embodiments according to the invention result from the dependent claims and the observations below.

Embodiments which are hereinafter designated as preferred are combined in particularly preferred embodiments with features of other embodiments designated as preferred. Very particularly preferred, therefore, are combinations of two or more of the embodiments designated below as particularly preferred. Also preferred are embodiments in which a feature of one embodiment that is designated in any degree as preferred is combined with one or more further features of other embodiments that are designated in any degree as preferred. Features of preferred pressure-sensitive adhesive tapes and uses result from the features of preferred adhesives.

In so far as both specific amounts or fractions of an element, for example for the tackifier resins or a particular monomer, and preferred embodiments of the element are disclosed subsequently for this element, it is the case in particular that the specific amounts or fractions of the preferably embodied elements are also disclosed. In addition, it is disclosed that with the corresponding specific total amounts or total fractions of the elements, at least a part of the elements can be preferably configured and in particular also that preferably configured elements within the specific total amounts or total fractions may in turn be present in the specific amounts or fractions.

The invention relates to a pressure-sensitive adhesive, comprising:
a) one or more poly(meth)acrylates having a weight-average molecular weight M_{w} of 200 000 g/mol or more in a combined mass fraction of 50% or more, based on the mass of the pressure-sensitive adhesive, and
b) one or more tackifier resins having a weight-average molecular weight M_{w} of 20 000 g/mol or less in a combined mass fraction in the range of 1 to 25%, based on the mass of the pressure-sensitive adhesive,
wherein the one or more tackifier resins are producible by polymerization of a first monomer composition comprising, based on the mass of the first monomer composition:
i) one or more first monomers selected from the group consisting of aromatic (meth)acrylates and styrene, in a combined mass fraction in the range of 5 to 40%,
ii) one or more second monomers selected from the group consisting of methyl methacrylate and ethyl methacrylate, in a combined mass fraction in the range of 35 to 68%, and
iii) one or more third monomers selected from the group consisting of (meth)acrylates having a cycloaliphatic radical, in a combined mass fraction in the range of 5 to 40%.

A pressure-sensitive adhesive is, in accordance with the expert understanding, an adhesive which has pressure-sensitive adhesive properties, i.e. the property of making a durable connection to an adhesion base even under relatively low applied pressure. Corresponding pressure-sensitive adhesive tapes are usually redetachable from the adhesion base after use, essentially free of residue, and are usually permanently self-adhesive even at room temperature, which means that they have a certain viscosity and touch-stickiness, so that they wet the surface of a substrate even with little applied pressure. The pressure-sensitive adhesiveness of a pressure-sensitive adhesive tape results from the fact that the adhesive used is a pressure-sensitive adhesive. Without wanting to be tied to this theory, it is often assumed that a pressure-sensitive adhesive can be considered as an extremely high-viscosity fluid with an elastic component, which consequently has characteristic viscoelastic properties, which lead to the above-described durable self-adhesiveness and pressure-sensitive adhesive capability. It is assumed that with corresponding pressure-sensitive adhesives, mechanical deformation results in both viscous flow processes and the build-up of elastic restoring forces. The proportional viscous flow is used to achieve adhesion, while the proportional elastic restoring forces are particularly necessary for achieving cohesion. The relationships between rheology and pressure-sensitive adhesiveness are known in the state of the art and are described, for example, in Satas, “Handbook of Pressure Sensitive Adhesive Technology”, third edition (1999), pages 153 to 203. The storage modulus (G′) and the loss modulus (G″), which can be determined by means of dynamic mechanical analysis (DMA), for example using a rheometer, as disclosed, for example, in WO 2015/189323, are usually used to characterize the extent of elastic and viscous components. In the context of the present invention, an adhesive is preferably understood as being pressure-sensitively adhesive and thus as a pressure-sensitive adhesive when at a temperature of 23° C. in the deformation frequency range from 10⁰ to 10¹ rad/sec, G′ and G″ are each at least in part in the range from 10³ to 10⁷ Pa.

The pressure-sensitive adhesive of the invention comprises poly(meth)acrylates and tackifier resins, which in turn are or can be produced from various monomers. These constituents are each used as “one or more” in accordance with the expert understanding. The term “one or more” refers here, in the manner usual in the sector, to the chemical nature of the compounds in question and not to the amount of substance thereof. For example, the first monomer composition may comprise as the first monomer exclusively styrene, which would mean that the monomer composition comprises a multiplicity of styrene molecules.

In the context of the present invention, the expression “poly(meth)acrylate” in accordance with the expert understanding embraces polyacrylates and polymethacrylates and also copolymers of these polymers. Poly(meth)acrylates may contain smaller amounts of monomer units that are not derived from (meth)acrylates. In the context of the present invention, a “poly(meth)acrylate” thus means a (co)polymer for which the monomer base consists to a mass fraction of 70% or more, preferably 90% or more, particularly preferably 98% or more, of monomers selected from the group consisting of acrylic acid, methacrylic acid, acrylic acid esters and methacrylic acid esters, based on the mass of the monomer base. Preferably, the mass fraction of acrylic acid esters and/or methacrylic acid esters is 50% or more, particularly preferably 70% or more. Poly(meth)acrylates are generally accessible by radical polymerization of acrylic-and/or methacrylic-based monomers and, optionally, other copolymerizable monomers.

The tackifier resins to be used according to the invention are or can be produced by polymerization of a first monomer composition which consists in large parts likewise of (meth)acrylates, so that the tackifier resins can be described as (meth)acrylate-based tackifier resins.

In accordance with the expert understanding and the usual procedure in the field of the art, it is expedient to define polymeric and oligomeric compounds such as the tackifier resins and the poly(meth)acrylates via the production process or the starting materials used for the production, since it is impossible to define the corresponding materials otherwise in a meaningful way.

The production of the poly(meth)acrylates and also of the (meth)acrylate-based tackifier resins from the respective monomers can take place according to the usual processes, in particular by conventional radical polymerizations or controlled radical polymerizations. The polymers or oligomers can be prepared by copolymerization of the monomeric components using the usual polymerization initiators and optionally chain transfer agents, where polymerization may be performed at the usual temperatures, for example, in bulk, in emulsion, e.g. in water or liquid hydrocarbons, or in solution. Preferably, the poly(meth)acrylates and/or the tackifier resins are produced by polymerization in solvents, more preferably in solvents having a boiling temperature in the range of 50 to 150° C., more preferably in the range of 60 to 120° C., using the usual amounts of polymerization initiators, with the polymerization initiators being added to the monomer composition generally in a proportion of about 0.01 to 5%, in particular from 0.1 to 2%, based on the mass of the monomer composition.

Suitable polymerization initiators are, for example, radical sources such as peroxides, hydroperoxides and azo compounds, e.g. dibenzoyl peroxide, cumene hydroperoxide, cyclohexanone peroxide, di-t-butyl peroxide, cyclohexylsulfonyl acetyl peroxide, diisopropyl percarbonate, t-butyl peroctoate or benzopinacol. Particularly preferably, 2,2′-azobis(2-methylbutyronitrile) or 2,2′-azobis(2-methylpropionitrile) is used as radical initiator. In particular, alcohols such as methanol, ethanol, n- and iso-propanol, n-and iso-butanol, preferably isopropanol and/or isobutanol, and also hydrocarbons such as toluene and, in particular, benzines with a boiling temperature in the range of 60 to 120° C. are candidates as solvents. In particular, ketones, such as acetone, methyl ethyl ketone and methyl isobutyl ketone, and esters, such as ethyl acetate, for example, and also mixtures of these solvents may be used.

In contrast to the tackifier resins, it is preferred for the poly(meth)acrylates, with a view to the adhesive properties of pressure-sensitive adhesive tapes of the invention, in particular for establishing high cohesion, for them to be partially crosslinked with one another by crosslinking, so that the pressure-sensitive adhesive comprises crosslinked poly(meth)acrylates. Preferred accordingly is a pressure-sensitive adhesive of the invention wherein the one or more poly(meth)acrylates are producible by a polymerization of a second monomer composition, and subsequent crosslinking of the polymers, wherein the crosslinking preferably takes place with a chemical crosslinker and/or a physical crosslinker. Preferably, the poly(meth)acrylates of the pressure-sensitive adhesive of the invention are thermally crosslinked using at least one covalent crosslinker or using a combination of at least one covalent crosslinker with at least one coordinative crosslinker.

Preferred covalent crosslinkers are epoxycyclohexyl derivatives and N,N-diglycidylamines. Preferred coordinative crosslinkers are chelate compounds, more particularly polyvalent metal chelate compounds. Thermal crosslinking regularly results in particularly homogeneous crosslinking, whereas, for example, a crosslinking profile with varying crosslinking density can be observed for radiation-crosslinked compositions.

Preferred thermal crosslinkers are N,N,N′,N′-tetrakis(2,3-epoxypropyl)cyclohexane-1,3-dimethylamine and N,N,N′,N′-tetrakis(2,3-epoxypropyl)-m-xylene-a,a′-diamine and epoxycyclohexyl carboxylates, in particular (3,4-epoxycyclohexane) methyl 3,4-epoxycyclohexylcarboxylate and bis(3,4-epoxycyclohexylmethyl) adipate.

Preferred coordinative crosslinkers are polyvalent metal chelate compounds in which a polyvalent metal is coordinatively bonded to one or more organic compounds. The polyvalent metal atom is preferably Al(III), Zr(IV), Co(II), Cu(I), Cu(II), Fe(II), Fe(III), Ni(II), V(II), V(III), V(IV), V(V), Zn(II), In(III), Ca(II), Mg(II), Mn(II), Y(III), Ce(II), Ce(IV), St(II), Ba(II), Mo(II), Mo(IV), Mo(VI), La(III), Sn(II) Sn(IV) and Ti(IV), in particular Al(III), Zr(IV) and Ti(IV). Ligands used are preferably alkyl esters, alcohol compounds, carboxylic acid compounds, ether compounds and ketone compounds. Particularly preferred coordinative crosslinkers are titanium dipropoxide bis(acetylacetonate), titanium dibutoxide bis(octyleneglycholate), titanium dipropoxide bis(ethyl acetoacetate), titanium dipropoxide bis(lactate), titanium dipropoxide bis(triethanolaminate), titanium di-n-butoxide bis(triethanolaminate), titanium tri-n-butoxide monostearate, butyl titanate dimer, poly(titanium acetylacetonate); aluminium diisopropoxide monoethyl acetate, aluminium di-n-butoxide monomethyl acetoacetate, aluminium di-i-butoxide monomethyl acetoacetate, aluminium di-n-butoxide monoethyl acetoacetate, aluminium di-sec-butoxide monoethyl acetoacetate, aluminium triacetylacetonate, aluminium monoacetylacetonate bis(ethylacetoacetonate) and zirconium tetraacetylacetonate; more particularly aluminium triacetylacetonate and aluminium diisopropoxide monoethyl acetate.

The skilled person understands that in pressure-sensitive adhesives of the invention both the poly(meth)acrylates and the tackifier resins are at least partly produced or producible from (meth)acrylates. In the above-recited definition of pressure-sensitive adhesives of the invention, for the purpose of a clear distinction between the high molecular weight poly(meth)acrylates and the shorter-chain tackifier resins, the weight-average molecular weight is defined in order to enable a clear distinction to be made between these components. In this way, the above information expresses the differences between the two components by the very parameters with which the skilled person also makes a distinction in practice between poly(meth)acrylates and the tackifier resins.

The weight-average molecular weight here is determined by gel permeation chromatography (GPC) on 100 mL of a clear-filtered sample (sample concentration 0.5 g/L). Tetrahydrofuran with 0.1% by volume of trifluoroacetic acid is used as the eluent. The measurement is carried out at 25° C. The guard column used is a PSS-SDV type column, 10 μm, ID 8.0 mm×50 mm. For separation, columns of the type PSS-SDV, 5 μm, 10³ Ä (SN9090201) and 5 μm, 10² Ä (SN9090200) with ID 8.0 mm×300 mm each are used (detection by differential refractometer PSS-SECurity 1260 RID). The flow rate is 0.5 mL per minute. The calibration is against PMMA standards (polymethyl methacrylate calibration).

However, the inventors have succeeded, for both components of the pressure-sensitive adhesive, in identifying preferred weight-average molecular weights which when established result in particularly advantageous pressure-sensitive adhesives of the invention. In particular for the tackifier resins, it has been found that comparatively short-chain tackifier resins can be used to achieve particularly good chemical resistance in conjunction with good pressure-sensitive adhesiveness. A pressure-sensitive adhesive of the invention is preferred, indeed, wherein the one or more poly(meth)acrylates have a weight-average molecular weight M_{w} of 400 000 g/mol or more, preferably of 500 000 g/mol or more, more preferably of 600 000 g/mol or more, very preferably 750 000 g/mol or more. Preferred additionally or alternatively is a pressure-sensitive adhesive of the invention wherein the one or more tackifier resins have a weight-average molecular weight M_{w} in the range of 1000 to 15 000 g/mol, preferably in the range of 1500 to 10 000 g/mol, more preferably in the range of 2000 to 5000 g/mol.

It can be seen as an advantage of the pressure-sensitive adhesives of the invention that in addition to the constituents provided according to the invention, further components can also be used therein, for example typical additives. However, it has proved to be particularly advantageous, especially with a view to optimal chemical resistance, if the pressure-sensitive adhesives consist largely only of the components specified above. Therefore, a pressure-sensitive adhesive of the invention is preferred wherein the combined mass fraction of the one or more poly(meth)acrylates and the one or more tackifier resins is 95% or more, preferably 98% or more, more preferably 99% or more, based on the mass of the pressure-sensitive adhesive.

In this context, it has proved to be a particular advantage of the pressure-sensitive adhesives of the invention that the fraction of the tackifier resin can be selected to be comparatively high, since the chemically resistant tackifier resins of the present invention have hardly any adverse effect, or none, on the chemical resistance of the pressure-sensitive adhesive, even at relatively large mass fractions. In this respect, the inventors were able to identify optimal mass ranges for resolving the conflict between good adhesive properties and high chemical resistance, including especially towards substances such as oleic acid. A pressure-sensitive adhesive of the invention is preferred, indeed, wherein the combined mass fraction of the one or more tackifier resins is in the range of 5 to 25%, preferably in the range of 7.5 to 22.5%, more preferably in the range of 10 to 20%, based on the mass of the pressure-sensitive adhesive. Preferred in addition or alternatively is a pressure-sensitive adhesive of the invention wherein the combined mass fraction of the one or more poly(meth)acrylates is 75% or more, preferably 77.5% or more, more preferably 80% or more, based on the mass of the pressure-sensitive adhesive.

It can be seen as a great advantage of the pressure-sensitive adhesives of the invention that the poly(meth)acrylates to be used can be selected very flexibly with regard to the chemical nature of the monomers, so that the pressure-sensitive adhesives can be specifically adapted to the respective requirements of a particular application, especially since many poly(meth)acrylates intrinsically have a favourable chemical resistance. Based on their own studies, as disclosed for example in WO 2019/106194 and WO 2019/106195, the inventors have succeeded, however, in providing particularly favourable compositions for the poly(meth)acrylates in the pressure-sensitive adhesives of the invention, which inherently have a particularly high chemical resistance, so that in combination with the advantageous tackifier resins, particularly powerful pressure-sensitive adhesives of the invention can be obtained. Preferred in particular is a pressure-sensitive adhesive of the invention wherein the one or more poly(meth)acrylates are producible by polymerization of a second monomer composition comprising, based on the mass of the second monomer composition:
iv) one or more fourth monomers selected from the group consisting of acrylic esters of the formula (I),

CH₂═CH—C(O)OR¹ (I),
wherein R¹ is a linear or branched alkyl group having 1 to 10 C atoms, preferably methyl acrylate, ethyl acrylate, n-butyl acrylate and ethylhexyl acrylate, in a combined mass fraction in the range of 30 to 80%, preferably in the range of 40 to 70%,
v) one or more fifth monomers selected from the group consisting of acrylic esters of the formula (II),

CH₂═CH—C(O)OR² (II),
wherein R² is a phenoxyalkyl radical or an alkoxyalkyl radical having 2 to 5 C atoms, preferably phenoxyethyl acrylate and methoxyethyl acrylate, in a combined mass fraction in the range of 20 to 70%, preferably in the range of 30 to 50%, and
vi) one or more sixth monomers selected from the group consisting of acrylate monomers of the formula (III),

CH₂═CH—C(O)OR³ (III),
wherein R³ is an H atom or a hydroxyalkyl radical having 1 to 4 C atoms, preferably acrylic acid, in a combined mass fraction in the range of 0.5 to 10%, preferably in the range of 1 to 5%,
and preferably additionally:
vii) one or more seventh monomers selected from the group consisting of acrylic esters of formula (IV),

CH₂═CH—C(O)OR⁴ (IV),
wherein R⁴ is an alkyldiglycol radical, preferably ethyldiglycol acrylate, in a combined mass fraction in the range of 0.5 to 40%, preferably in the range of 5 to 20%.

According to the invention, the tackifier resins are obtained by polymerization of a first monomer composition comprising various monomers, namely first monomers selected from the group consisting of aromatic (meth)acrylates and styrene, second monomers selected from the group consisting of methyl methacrylate and ethyl methacrylate, and third monomers selected from the group consisting of (meth)acrylates with a cycloaliphatic radical. In accordance with the usual nomenclature, (meth)acrylates with a cycloaliphatic radical are esters of (meth)acrylic acid which have a cycloaliphatic ring, i.e. a ring which is not an aromatic, in the radical attached via the ester functionality. Accordingly, the third monomers themselves are cycloaliphatic compounds, sometimes referred to as alicyclic compounds.

According to the inventors' knowledge, the above-stated mass fractions for the first, second and third monomers in the first monomer composition, with their lower limits, define the respective minimum of the corresponding monomers with which tackifier resins can be obtained which, when used in poly(meth)acrylate-based pressure-sensitive adhesives, lead to excellent chemical resistance, since they have hardly any adverse effect, or none, on the inherent chemical resistance of the poly(meth)acrylate-based pressure-sensitive adhesives.

It may be seen as an advantage of the pressure-sensitive adhesives of the invention that the tackifier resins can at least partly also be produced from further monomers; in the estimation of the inventors, however, the proportion of further monomers should be kept fairly low in order to maximize the chemical resistance. However, the use of further monomers, in particular of thiols, allows a targeted adjustment of the physico-chemical properties of the tackifier resins, which makes it easier optimally to meet other requirement profiles apart from the chemical resistance. Therefore, a pressure-sensitive adhesive of the invention is preferred wherein the first monomer composition, based on the mass of the first monomer composition, comprises one or more further monomers in a combined mass fraction in the range of 0 to 50%, preferably in the range of 0.1 to 30%, more preferably in the range of 0.5 to 15%, the further monomers being preferably selected from the group consisting of other (meth)acrylates and thiols, preferably thiols, more preferably dodecanethiol and 2-ethylhexyl 3-mercaptopropionate.

Alternatively, a pressure-sensitive adhesive of the invention is preferred wherein the combined mass fraction of the first monomers, second monomers and third monomers in the first monomer composition, based on the mass of the first monomer composition, is 80% or more, preferably 90% or more, very preferably 98% or more.

Based on their own experiments, the inventors have come to the surprising finding that the observed advantageous properties with regard to the composition of the tackifier resin only show themselves in a comparatively narrow compositional corridor of the three monomer classes, as defined above. Based on this compositional corridor, the inventors have also succeeded in identifying particularly advantageous compositions with which particularly powerful tackifier resins can be obtained. A pressure-sensitive adhesive of the invention is preferred, indeed, wherein the first monomer composition, based on the mass of the first monomer composition:
i1) comprises the one or more first monomers in a combined mass fraction in the range of 7.5 to 35%, preferably in the range of 10 to 30%, and/or
ii1) comprises the one or more second monomers in a combined mass fraction in the range of 40 to 65%, preferably in the range of 45 to 60%, and/or
iii1) comprises the one or more third monomers in a combined mass fraction in the range of 7.5 to 35%, preferably in the range of 10 to 30%. It is particularly preferred for the corresponding ranges or preferred ranges to be established accordingly for two or more, preferably all, of the monomers.

In addition, the inventors have succeeded in identifying particularly suitable compounds for the first, second and third monomers that result in particularly powerful tackifier resins that can be used in pressure-sensitive adhesives of the invention which have a particularly high chemical resistance. Preferably, therefore, a pressure-sensitive adhesive of the invention is used wherein, in the first monomer composition:
i2) the one or more first monomers are selected from the group consisting of aromatic (meth)acrylates, preferably aromatic methacrylates, more preferably benzyl methacrylate and phenoxyethyl methacrylate, very preferably benzyl methacrylate, and/or
ii2) the one or more second monomers are selected from the group consisting of methyl methacrylate and ethyl methacrylate, preferably methyl methacrylate, and/or
iii2) the one or more third monomers are selected from the group consisting of methacrylates having a cycloaliphatic radical, preferably cyclohexyl methacrylate, isobornyl methacrylate, dicyclopentanyl methacrylate and norbornyl methacrylate, preferably cyclohexyl methacrylate. It is also particularly preferred here if the corresponding compounds or preferred or more preferred compounds are selected accordingly for two or more, preferably all, of the above monomers, these preferred monomers being especially preferably used in each case in the preferred mass fractions.

It has become apparent that the addition of one or more plasticizers can improve the shock resistance of pressure-sensitive adhesives of the invention without significantly affecting the chemical resistance. Preferably, the pressure-sensitive adhesive of the invention accordingly comprises at least one plasticizer, wherein the plasticizer is more preferably selected from the group consisting of (meth)acrylate oligomers, phthalates, hydrocarbon oils, cyclohexanedicarboxylic esters, benzoic esters, water-soluble plasticizers, plasticizing resins, phosphates and polyphosphates, more preferably phthalates, cyclohexanedicarboxylic esters and benzoic esters, very preferably benzoic esters. Preferably, the pressure-sensitive adhesive of the invention comprises plasticizers in a mass fraction of 30% or less, preferably 20% or less, more preferably 15% or less. In order to further optimize the physico-chemical properties of the pressure-sensitive adhesive of the invention, it may also contain other common additives such as fillers, for example electrically conductive filling materials, thermally conductive filling materials or flame retardants, for example ammonium polyphosphate and its derivatives.

In one preferred embodiment, the pressure-sensitive adhesive of the invention is foamed. A “foamed pressure-sensitive adhesive” is a pressure-sensitive adhesive comprising a pressure-sensitive adhesive matrix material and multiple gas-filled cavities, so that the density of this pressure-sensitive adhesive is reduced compared to the mere matrix material without cavities. The foaming of the matrix material of the foamed pressure-sensitive adhesive can in principle be brought about in any desired way. For example, the pressure-sensitive adhesive may be foamed by means of a propellant gas introduced or released therein. Preferably, the foamed pressure-sensitive adhesive contains at least partially expanded hollow microspheres. These comprehend at least partially expanded microspheres which are elastic and expandable in their basic state and have a thermoplastic polymer shell. These spheres are-in the basic state-filled with low-boiling liquids or liquefied gas. Shell material employed is especially polyacrylonitrile, PVDC, PVC or polyacrylates. In particular, hydrocarbons of the lower alkanes, for example isobutane or isopentane, which are enclosed as a liquefied gas under pressure in the polymer shell, are conventional as low-boiling liquids. The term “microballoons” is also conventional for such microspheres. The outer polymer shell of these microballoons softens as a result of exposure to heat. At the same time, the liquid propellant gas present within the shell is converted to its gaseous state. This causes irreversible extension and three-dimensional expansion of the microballoons. The expansion has ended when the internal and external pressure are balanced. Since the polymeric shell is preserved, the result is a closed-cell foam; syntactic foaming is also talked of in this regard.

Pressure-sensitive adhesives of the invention can be used for example directly as adhesives, and depending on the application method, they can also be provided in the form of tapes, for example. With a view to extremely favourable handling properties, particularly advantageous results are regularly achieved, however, when pressure-sensitive adhesives of the invention are used as an adhesive layer of a single-or double-sided pressure-sensitive adhesive tape which also comprises a carrier layer. The invention therefore also relates to a pressure-sensitive adhesive tape comprising a carrier layer and, as a pressure-sensitive adhesive, a pressure-sensitive adhesive of the invention.

The term adhesive tape is clear to the skilled person in the field of adhesive technology. In the context of the present invention, the expression “tape” refers to all thin, flat structures, i.e. structures with a predominant extent in two dimensions, more particularly films, film portions and labels, preferably tapes with extended length and limited width, and corresponding tape portions.

The carrier layer usually refers to the layer of such a multilayer adhesive tape that significantly determines the mechanical and physical properties of the adhesive tape, such as the tear resistance, stretchability, insulation capacity or restoring capacity. Common materials for the carrier layer are, for example, woven fabrics, laid scrims and polymeric films, for example PET films and polyolefin films. However, the carrier layer can also be pressure-sensitively adhesive itself. The pressure-sensitive adhesive tape of the invention may in one preferred embodiment be a double-sided pressure-sensitive adhesive tape in which the carrier layer is provided on both sides with a pressure-sensitive adhesive of the invention. In pressure-sensitive adhesive tapes of the invention, the adhesive layers may be lined with a so-called release liner in order to enable trouble-free unwinding and to protect the pressure-sensitive adhesive from contamination.

Such release liners usually consist of a one-or two-sidedly siliconized polymeric film (e.g. PET or PP) or a siliconized paper carrier.

The use of a pressure-sensitive adhesive tape of the invention for bonding two or more components for generating a chemically resistant bond is also disclosed, starting from the pressure-sensitive adhesive tape of the invention.

In the light of the observations above, the skilled person understands that the specifically synthesized tackifier resins themselves and their use for the simultaneous improvement of the pressure-sensitive adhesive properties and preservation of the chemical resistance are also inherently advantageous in poly(meth)acrylate-based pressure-sensitive adhesives. Accordingly, the invention also relates to the use of one or more tackifier resins for boosting the peel adhesion strength in (meth)acrylate-based adhesives and for boosting the chemical resistance, wherein the one or more tackifier resins are producible by polymerization of a first monomer composition comprising, based on the mass of the first monomer composition:
i) one or more first monomers selected from the group consisting of aromatic (meth)acrylates and styrene, in a combined mass fraction in the range of 5 to 40%,
ii) one or more second monomers selected from the group consisting of methyl methacrylate and ethyl methacrylate, in a combined mass fraction in the range of 35 to 68%, and
iii) one or more third monomers selected from the group consisting of (meth)acrylates having a cycloaliphatic radical, in a combined mass fraction in the range of 5 to 40%.

Preferred embodiments of the invention are further explained and described below, with reference to experiments.

### 1. Production of the poly(meth)acrylates

TABLE 1
Composition of the poly(meth)acrylates,
data in mass fractions in %

| Substance | P1 | P2 | P3 | P4 | P5 |
|---|---|---|---|---|---|
| Acrylic acid | 3 | 3 | 3 | 3 | 3 |
| n-Butyl acrylate | 47 | 47 | 47 | 47 | 57 |
| Phenoxyethyl acrylate | 30 | 50 | 30 | 30 | 20 |
| Methyl acrylate | 20 | 0 | 0 | 0 | 0 |
| Ethyl acrylate | 0 | 0 | 0 | 10 | 20 |
| Ethylhexyl acrylate | 0 | 0 | 0 | 10 | 0 |
| Methoxyethyl acrylate | 0 | 0 | 20 | 0 | 0 |

A conventional reactor for radical polymerizations was charged with 100 kg of the specified monomers in the specified mass fractions and 72.4 kg of an ethyl acetate/isopropanol mixture (95:5) for the production of the poly(meth)acrylates P1 to P5 listed in Table 1.

After 45 minutes of passing nitrogen gas through the reactor with stirring, the reactor was heated to 58° C. and 50 g of 2,2′-azobis(2-methylbutyronitrile) were added. Subsequently, the external heating bath was heated to 70° C. and the reaction was conducted constantly at this external temperature. After 1 h, a further 50 g of 2,2′-azobis(2-methylbutyronitrile) were added. After 2, 3 and 4 h, the batch was diluted each time with 15 kg of ethyl acetate/isopropanol mixture (95:5).

After 5.5 h and after 7 h, the batch was re-initiated each time with 150 g of bis(4-tert-butylcyclohexyl) peroxydicarbonate. After a reaction time of 22 h, the polymerization was stopped and the mixture was cooled to room temperature. Nearly quantitative conversions were achieved in each case.

### 2. Production of the Tackifier Resins

TABLE 2
Composition of the tackifier resins,
data in mass fractions in %

| Substance | H1 | H2 | H3 | H4 | H5 | H6 | H7 |
|---|---|---|---|---|---|---|---|
| Methyl methacrylate | 45 | 65 | 70 | 65 | 60 | 60 | 45 |
| Cyclohexyl methacrylate | 45 | 15 | 10 | 15 | 20 | 15 | 15 |
| Styrene | 0 | 10 | 10 | 0 | 0 | 0 | 0 |
| Benzyl methacrylate | 0 | 0 | 0 | 10 | 10 | 15 | 30 |
| Dodecanethiol | 10 | 10 | 10 | 10 | 10 | 10 | 10 |

A conventional reactor for radical polymerizations was charged with 100 kg of the specified monomers in the specified mass fractions and 72.4 kg of an acetone/isopropanol mixture (96:4) for the production of the tackifier resins H1 to H7 listed in Table 2.

After 45 minutes of passing nitrogen gas through the reactor with stirring, the reactor was heated to 58° C. and 444 g of 2,2′-azobis(2-methylbutyronitrile) (5% by weight in acetone) were added. Subsequently, the external heating bath was heated to 75° C. and the reaction was conducted constantly at this external temperature. After 7 h reaction time, a further 444 g of 2,2′-azobis(2-methylbutyronitrile) (5% by weight in acetone) were added. The reaction was terminated after 22 h reaction time and cooling took place to room temperature. Nearly quantitative conversions were achieved in each case.

### 3. Production of the Pressure-Sensitive Adhesives

TABLE 3
Composition of the pressure-sensitive adhesives

| | | Type | Mass fraction |
|---|---|---|---|
| | Type | Tackifier | Tackifier |
| PSA | Polymer | resin | resin/% |
| V1 | P1 | — | — |
| V2 | P1 | H1 | 10 |
| E1 | P1 | H4 | 10 |
| E2 | P1 | H7 | 10 |
| V3 | P2 | — | — |
| V4 | P2 | H1 | 10 |
| V5 | P2 | H1 | 20 |
| E3 | P2 | H2 | 5 |
| E4 | P2 | H2 | 10 |
| E5 | P2 | H2 | 20 |
| V6 | P2 | H2 | 30 |
| V7 | P2 | H3 | 10 |
| V8 | P2 | H3 | 20 |
| V9 | P3 | — | — |
| E6 | P3 | H4 | 20 |
| E7 | P3 | H5 | 20 |
| E8 | P3 | H6 | 20 |
| V10 | P4 | — | — |
| E9 | P4 | H4 | 20 |
| E10 | P4 | H7 | 20 |
| V11 | P5 | — | — |
| E11 | P5 | H7 | 20 |
| E12 | P5 | H7 | 25 |

The inventive pressure-sensitive adhesives E1 to E12 and the non-inventive pressure-sensitive adhesives V1 to V11 were produced in accordance with Table 3 in each case by mixing the corresponding poly(meth)acrylates P1 to P5 with the tackifier resins H1 to H7 in the specified mass fractions.

Each pressure-sensitive adhesive was additionally blended with 0.05% by weight, based on the poly(meth)acrylate, of the crosslinker N,N,N′, N′-tetrakis(2,3-epoxypropyl)-m-xylene-a,a′-diamine to crosslink the poly(meth)acrylate; the tackifier resins are not crosslinked as well, as they lack suitable functionalities. The mixture was subsequently diluted with ethyl acetate to a solids content of 30% by weight and then coated from solution onto a siliconized release film (50 μm polyester PET). (Coating speed 2.5 m/min, drying tunnel 15 m, temperatures zone 1: 40° C., zone 2: 70° C., zone 3: 95° C., zone 4: 105° C.). The coating weight was 50 g/m².

### 4. Peel Adhesion and Chemical Resistance Tests

After removal of the siliconized PET film, the adhesive tapes obtained as described in section 2 above were applied to a previously cleaned ASTM steel plate in a width of 10 mm each, and rolled down five times in each direction back and forth with a 4 kg roller. Subsequently, the resulting bonds were stored for 24 h under standard conditions (air, 23° C., 50% relative humidity).

The sample specimens were then stored for 72 h in a sealed box in a water bath conditioned at 60° C., one sample being immersed in one of the test chemicals and then completely surrounded by it, while the respective control sample was stored in air.

The test chemicals used were oleic acid with a purity of >85% and an ethanol/water mixture (85/15, mass fractions). After the boxes were removed from the water bath and the sample specimens from the boxes, the sample specimens were carefully cleaned with a cloth and after 2 h conditioning under the standard conditions, the peel adhesion was determined.

The peel adhesion was determined under test conditions of 23° C. +/−1° C. temperature and 50% +/−5% relative humidity. The adhesive tape was removed from the steel substrate at a speed of 300 mm/min and at an angle of 180°. The measurement results in Table 4 are expressed in N/cm and correspond to the average of three measurements.

The adhesive tapes are considered to be resistant to the respective test chemicals if they still show a peel adhesion of at least 1.0 N/cm after storage in the respective test chemical. It is advantageous if the difference in the peel adhesion between the reference sample and the samples stored in the test chemicals is as small as possible. In summary, a sample as a whole is only considered to be sufficiently chemically resistant if, after storage, a peel adhesion of at least 1.0 N/cm is still present relative to both test chemicals.

TABLE 4
Peel adhesion of the pressure-sensitive adhesives
Data in N/cm

| | Control | Oleic acid | Ethanol/water | |
|---|---|---|---|---|
| PSA | Peel adhesion | Peel adhesion | Peel adhesion | Total |
| V1 | 6.4 | 4.0 | 4.2 | Resistant |
| V2 | 7.7 | 0.3 | 4.7 | Not resistant |
| E1 | 7.4 | 4.3 | 2.0 | Resistant |
| E2 | 8.3 | 4.2 | 2.3 | Resistant |
| V3 | 6.4 | 3.8 | 5.7 | Not resistant |
| V4 | 7.9 | 0.0 | 3.2 | Not resistant |
| V5 | 10.2 | 0.0 | 1.5 | Not resistant |
| E3 | 6.4 | 3.7 | 5.8 | Resistant |
| E4 | 8.2 | 2.6 | 2.3 | Resistant |
| E5 | 12.1 | 2.7 | 2.6 | Resistant |
| V6 | 13.2 | 0.0 | 2.6 | Not resistant |
| V7 | 5.9 | 0.0 | 4.7 | Not resistant |
| V8 | 9.4 | 0.7 | 5.3 | Not resistant |
| V9 | 7.1 | 4.5 | 2.4 | Resistant |
| E6 | 11.4 | 2.3 | 2.0 | Resistant |
| E7 | 12.3 | 2.0 | 1.7 | Resistant |
| E8 | 11.8 | 2.1 | 1.7 | Resistant |
| V10 | 6.4 | 2.2 | 3.5 | Resistant |
| E9 | 7.9 | 2.2 | 3.2 | Resistant |
| E10 | 7.5 | 2.3 | 3.1 | Resistant |
| V11 | 6.0 | 3.2 | 2.5 | Resistant |
| E11 | 7.2 | 2.8 | 2.3 | Resistant |
| E12 | 7.2 | 2.7 | 2.0 | Resistant |

The measured values compiled in Table 4 clearly show that all the poly(meth)acrylates used are chemically resistant to a certain extent without the addition of tackifier resins, and so are suitable reference systems for evaluating the influence of the tackifier resins.

All tackifier resins in inventive pressure-sensitive adhesives reliably lead in the control samples to an improved peel adhesion compared to the tackifier resin-free comparative samples, so demonstrating the high suitability of the corresponding systems as tackifier resins. However, it can also be seen from the experiments that even with the specific tackifier resins of the present invention, the mass fraction should not be increased too much, since the resistance to oleic acid is reduced too much in the case of too great a mass fraction (cf. Pressure-sensitive adhesive V6).

With a view to the composition of the tackifier resins, the comparison with the pressure-sensitive adhesives V7 and V8 shows in particular that the content of second monomers is just too high at 70% and that the resistance to oleic acid in these pressure-sensitive adhesives is too negatively influenced for a positive overall evaluation, even if excellent resistances to ethanol/water can be achieved with these tackifier resins and the corresponding pressure-sensitive adhesives.

It should be noted that all the inventive pressure-sensitive adhesives for both test chemicals still show a peel adhesion of at least 1.0 N/cm after storage and are thus sufficiently resistant in the overall evaluation.

### 5. Push-Out Test

A square sample in the shape of a frame was cut out of the adhesive tape to be examined (external dimensions 33 mm×33 mm; border width 2.0 mm; internal dimensions (window cut-out) 29 mm×29 mm). This sample was adhered to a polycarbonate (PC) frame (external dimensions 45 mm×45 mm; border width 10 mm; internal dimensions (window cut-out) 25 mm×25 mm; thickness 3 mm). A PC window of 35 mm×35 mm was adhered to the other side of the double-sided adhesive tape. The bonding of PC frame, adhesive tape frame and PC window was done in such a way that the geometric centres and the diagonals each lay on top of one another (corner-to-corner). The bond area was 248 mm². The bond was pressed for 5 s at 248 N and stored for 24 hours at a temperature of 23° C. and 50% relative humidity.

The bonded test frames were then stored for 24 h in a sealed box in a water bath conditioned at 60° C., with one sample stored immersed in one of the test chemicals and then completely surrounded by it, whereas the respective control sample was stored in air.

Immediately after the storage described above, the adhesive assembly made up of PC frame, adhesive tape and PC window was dried off and clamped by the protruding edges of the PC frame into a sample holder in such a way that the assembly was aligned horizontally and the PC window was below the frame. The sample holder was then inserted centrally into the provided receiver in a Zwick testing machine. The sample head was lowered vertically onto the plate at a speed of 10 mm/s (measuring conditions 23° C., 50% relative humidity). Table 5 reports the force in N required to push out the PC window. The values reported correspond to the average of five measurements.

TABLE 5
Push-Out test
Data in N

| | Control | Oleic acid | Ethanol/water |
|---|---|---|---|
| PSA | Push Out | Push Out | Push Out |
| V9 | 108 | 25 | 16 |
| E6 | 232 | 79 | 34 |
| E7 | 220 | 72 | 40 |
| E8 | 213 | 80 | 41 |
| V10 | 289 | 24 | 101 |
| E9 | 302 | 30 | 76 |
| E10 | 305 | 26 | 67 |
| V11 | 234 | 29 | 30 |
| E11 | 249 | 33 | 58 |
| E12 | 264 | 28 | 36 |

The measured values compiled in Table 5 confirm that all the inventive pressure-sensitive adhesives exhibit good resistance for both test chemicals and also noticeably improve the adhesive properties in the control samples. In this context, it is noted that the residual peel adhesion of the inventive samples after the chemical exposure is in many cases in fact better than that of the tackifier resin-free systems. In particular, the tackifier resins H4, H5 and H6 of the pressure-sensitive adhesives E6 to E9 have particularly advantageous properties.

1. (canceled)

2. (canceled)

3. (canceled)

4. (canceled)

5. (canceled)

6. (canceled)

7. (canceled)

8. (canceled)

9. (canceled)

10. (canceled)

11. A pressure-sensitive adhesive, comprising:
a) one or more poly(meth)acrylates having a weight-average molecular weight M_{w} of 200 000 g/mol or more in a combined mass fraction of 50% or more, based on the mass of the pressure-sensitive adhesive, and
b) one or more tackifier resins having a weight-average molecular weight M_{w} of 20 000 g/mol or less in a combined mass fraction in the range of 1 to 25%, based on the mass of the pressure-sensitive adhesive,
wherein the one or more tackifier resins are producible by polymerization of a first monomer composition comprising, based on the mass of the first monomer composition:
i) one or more first monomers selected from the group consisting of aromatic (meth)acrylates and styrene, in a combined mass fraction in the range of 5 to 40%,
ii) one or more second monomers selected from the group consisting of methyl methacrylate and ethyl methacrylate, in a combined mass fraction in the range of 35 to 68%, and
iii) one or more third monomers selected from the group consisting of (meth)acrylates having a cycloaliphatic radical, in a combined mass fraction in the range of 5 to 40%.

12. The pressure-sensitive adhesive according to claim 11, wherein the combined mass fraction of the one or more poly(meth)acrylates is 75% or more, based on the mass of the pressure-sensitive adhesive.

13. The pressure-sensitive adhesive according to claim 11, wherein the combined mass fraction of the one or more tackifier resins is in the range of 5 to 25%, preferably in the range of 7.5 to 22.5%, more preferably in the range of 10 to 20%, based on the mass of the pressure-sensitive adhesive.

14. The pressure-sensitive adhesive according to claim 11, wherein the combined mass fraction of the one or more poly(meth)acrylates and the one or more tackifier resins is 95% or more, based on the mass of the pressure-sensitive adhesive.

15. The pressure-sensitive adhesive according to claim 11, wherein the one or more poly(meth)acrylates are producible by polymerization of a second monomer composition comprising, based on the mass of the second monomer composition:
iv) one or more fourth monomers selected from the group consisting of acrylic esters of the formula (I),
CH₂═CH—C(O)OR¹ (I),
wherein R¹ is a linear or branched alkyl group having 1 to 10 C atoms, preferably methyl acrylate, ethyl acrylate, n-butyl acrylate and ethylhexyl acrylate, in a combined mass fraction in the range of 30 to 80%;
v) one or more fifth monomers selected from the group consisting of acrylic esters of the formula (II),
CH₂═CH—C(O)OR² (II),
wherein R² is a phenoxyalkyl radical or an alkoxyalkyl radical having 2 to 5 C atoms, preferably phenoxyethyl acrylate and methoxyethyl acrylate, in a combined mass fraction in the range of 20 to 70%, and
vi) one or more sixth monomers selected from the group consisting of acrylate monomers of the formula (III),
CH₂═CH—C(O)OR³ (III),
wherein R³ is an H atom or a hydroxyalkyl radical having 1 to 4 C atoms, preferably acrylic acid, in a combined mass fraction in the range of 0.5 to 10%, preferably in the range of 1 to 5%.

16. The pressure-sensitive adhesive according to claim 11, wherein the combined mass fraction of the first monomers, second monomers and third monomers in the first monomer composition, based on the mass of the first monomer composition, is 80% or more, preferably 90% or more.

17. The pressure-sensitive adhesive according to claim 11, wherein the first monomer composition, based on the mass of the first monomer composition:
i1) comprises the one or more first monomers in a combined mass fraction in the range of 7.5 to 35%, and/or
ii1) comprises the one or more second monomers in a combined mass fraction in the range of 40 to 65%, and/or
iii1) comprises the one or more third monomers in a combined mass fraction in the range of 7.5 to 35%.

18. The pressure-sensitive adhesive according to claim 11, wherein in the first monomer composition:
i2) the one or more first monomers are selected from the group consisting of aromatic (meth)acrylates, preferably aromatic methacrylates, more preferably benzyl methacrylate and phenoxyethyl methacrylate, very preferably benzyl methacrylate, and/or
ii2) the one or more second monomers are selected from the group consisting of methyl methacrylate and ethyl methacrylate, preferably methyl methacrylate, and/or
iii2) the one or more third monomers are selected from the group consisting of methacrylates having a cycloaliphatic radical, preferably cyclohexyl methacrylate, isobornyl methacrylate, dicyclopentanyl methacrylate and norbornyl methacrylate, preferably cyclohexyl methacrylate.

19. The pressure-sensitive adhesive tape comprising a carrier layer and, as a pressure-sensitive adhesive, a pressure-sensitive adhesive according to claim 11.

20. A method of boosting the peel adhesion strength in poly(meth)acrylate-based adhesives and boosting the chemical resistance, comprising the use of one or more tackifier resins producible by polymerization of a first monomer composition comprising, based on the mass of the first monomer composition:
i) one or more first monomers selected from the group consisting of aromatic (meth)acrylates and styrene, in a combined mass fraction in the range of 5 to 40%,
ii) one or more second monomers selected from the group consisting of methyl methacrylate and ethyl methacrylate, in a combined mass fraction in the range of 35 to 68%, and
iii) one or more third monomers selected from the group consisting of (meth)acrylates having a cycloaliphatic radical, in a combined mass fraction in the range of 5 to 40%.

21. The pressure-sensitive adhesive according to claim 12, wherein the combined mass fraction of the one or more poly(meth)acrylates is 77.5% or more, based on the mass of the pressure-sensitive adhesive.

22. The pressure-sensitive adhesive according to claim 22, wherein the combined mass fraction of the one or more poly(meth)acrylates 80% or more, based on the mass of the pressure-sensitive adhesive.

23. The pressure-sensitive adhesive according to claim 14, wherein the combined mass fraction of the one or more poly(meth)acrylates and the one or more tackifier resins is 98% or more, based on the mass of the pressure-sensitive adhesive.

24. The pressure-sensitive adhesive according to claim 15, wherein the one or more poly(meth)acrylates are producible by polymerization of a second monomer composition comprising, based on the mass of the second monomer composition, wherein the:
iv) one or more fourth monomers selected from the group consisting of acrylic esters of the formula (I),
CH₂═CH—C(O)OR¹ (I),
is selected from methyl acrylate, ethyl acrylate, n-butyl acrylate and ethylhexyl acrylate.

25. The pressure-sensitive adhesive according to claim 15, wherein the one or more poly(meth)acrylates are producible by polymerization of a second monomer composition comprising, based on the mass of the second monomer composition, wherein the:
v) one or more fifth monomers selected from the group consisting of acrylic esters of the formula (II),
CH₂═CH—C(O)OR² (II),
is selected from phenoxyethyl acrylate and methoxyethyl acrylate.

26. The pressure-sensitive adhesive according to claim 15, wherein the one or more poly(meth)acrylates are producible by polymerization of a second monomer composition comprising, based on the mass of the second monomer composition, wherein the:
vi) one or more sixth monomers selected from the group consisting of acrylate monomers of the formula (III),
CH₂═CH—C(O)OR³ (III),
is acrylic acid.

27. The pressure-sensitive adhesive according to claim 16, wherein the combined mass fraction of the first monomers, second monomers and third monomers in the first monomer composition, based on the mass of the first monomer composition, is 90% or more.

28. The pressure-sensitive adhesive according to claim 18, wherein in the first monomer composition:
i2) the one or more first monomers is one or more aromatic (meth)acrylates selected from the group consisting of benzyl methacrylate and phenoxyethyl methacrylate.

29. The pressure-sensitive adhesive according to claim 18, wherein in the first monomer composition:
li2) the one or more second monomers are selected from the group consisting of methyl methacrylate and ethyl methacrylate.

30. The pressure-sensitive adhesive according to claim 18, wherein in the first monomer composition:
iii2) the one or more third monomers based on methacrylates having a cycloaliphatic radical, are selected from the group consisting of cyclohexyl methacrylate, isobomyl methacrylate, dicyclopentanyl methacrylate and norbornyl methacrylate.
